(19) United States
(12) Patent Application Publication
(10) Pub. No.: US 2010/0276547 A1
(43) Pub. Date: Nov. 4, 2010

(54) SYSTEMS FOR SOLAR POWER BEAMING FROM SPACE

(76) Inventors: Alexander M. Rubenchik, Livermore, CA (US); John M. Parker, Tracy, CA (US); Robert M. Yamamoto, Sacramento, CA (US); Raymond J. Beach, Livermore, CA (US)

Correspondence Address: LLNS / John P. Wooldridge;John H. Lee, Assistant Laboratory Counsel, L-703, P.O Box 808, Livermore, CA, 94551, US

(21) Appl. No.: 12/773,036

(22) Filed: May 4, 2010

Related U.S. Application Data
(60) Provisional application No. 61/175,333, filed on May 4, 2009.

(51) Int. Cl. B64G 1/44; F21V 5/00

(52) U.S. Cl. 244/172.8; 362/311.01

(57) ABSTRACT

A low earth orbit system for beaming energy to earth includes a solar reflector that collects and focuses solar light onto a solar panel, transforming it into electricity to drive a diode pumped laser, which then produces a high-power laser beam that is directed to a receiver on the surface of the Earth via a diffractive lens. A steering system of optics and automated hardware controls the beam direction.

### CROSS-REFERENCE TO RELATED APPLICATIONS

This application claims the benefit of U.S. Provisional Patent Application No. 61/175,333 titled “A Compact and Eco-Friendly System For Solar Power Beaming From Space To Earth,” filed May 4, 2009, incorporated herein by reference.

### STATEMENT REGARDING FEDERALLY SPONSORED RESEARCH OR DEVELOPMENT

The United States Government has rights in this invention pursuant to Contract No. DE-AC52-07NA27344 between the United States Department of Energy and Lawrence Livermore National Security, LLC.

### BACKGROUND OF THE INVENTION

1. Field of the Invention

The present invention generally relates to the field of clean renewable energy sources, and more specifically, it relates to collection of solar energy.

2. Description of Related Art

Over the years much has been written about the need for the world to invest in clean renewable energy sources. Estimates have been made on the total amount of energy needed worldwide as populations increase. Discussions have included the need to look for alternatives to fossil fuel, as the scarcity of hydrocarbon-based fuels is ever increasing, and with it, increased political and social unrest. Pollution control and issues associated with climate change also support the need to develop clean renewable energy sources. A solution to this problem can be found in the development and use of solar energy, which is plentiful, clean and for all practical purposes provides a limitless source of power.

Large-scale collection of solar energy on the surface of the earth is problematic for several reasons. First, solar radiation has low energy density, and consequently very large areas of solar collectors are required. This equates to an excessive amount of materials and infrastructure needed to build such a terrestrial-based solar energy collection system. In addition, these solar collectors would block sunlight from hitting the ground, causing potential ecological impacts, as well as changing the local thermal balance. Cloud cover also has an impact on the effectiveness of solar energy collection at the earth's surface, making it an inconsistent and unreliable energy source. The collection of solar energy in space mitigates many of these problems.

The idea of harvesting energy in space and then transporting it to the ground for use has been around since the dawn of the space age. However, initial proposals made use of converting sun-generated electricity into microwaves, which could then be power-beamed to the ground. The arguments in favor of the microwave concept were high conversion efficiencies in space and on the ground, with good transmission through the atmosphere even during periods of heavy cloud cover. The main problems with using a microwave-based system are the huge size of the required receiver on earth and the stringent performance requirements of the focusing system. In the 1970s, scientists at Lawrence Livermore National Laboratory (LLNL) suggested using laser light instead of microwaves, thereby reducing the requisite focal spot size; which in turn reduced by a thousand fold the overall size requirements for the receiver and focusing optics. Nevertheless, start up costs of billions of dollars prevented any serious consideration of this solution to the problem. Two significant factors contributing to the huge cost of deploying a space-based solar power system have been 1) the low laser efficiency and the resulting large volume and weight—requiring multiple vehicle launches, and 2) the need for human participation to activate the system in space orbit.

Therefore, a spaced based solar power collection system that transports energy to the surface of the earth and at least overcomes the above described problems is desirable.

### SUMMARY OF THE INVENTION

It is an object of the present invention to provide space based solar power systems, and methods of their use, capable of efficiently beaming collected solar energy from space to receiver stations located at the surface of the earth.

This and other objects will be apparent based on the disclosure herein.

The invention provides space based solar power systems for efficiently beaming collected solar energy from space to receiver stations located at the earth's surface. A technological advancement that supports this concept is the development of diode pumped, efficient lightweight laser systems that can effectively transform the electric energy to the light and to transmit a coherent laser beam from space to Earth with high efficiency and reliable operation. In some embodiments, the laser has a near infrared wavelength (e.g., 795 nanometers) that supports efficient transport through the earth's atmosphere, with the related attribute of requiring a correspondingly very small receiver on Earth of a mere few meters in diameter. A low earth orbit (LEO) has been chosen in some embodiments to facilitate current launch system capabilities, which also reduces laser beam and optical system pointing and alignment requirements. Recent advances in laser and optical technology at LLNL and elsewhere have made it possible to deploy a space-based system capable of delivering about 1 MW of energy to a terrestrial receiver station. The entire spaced based solar power system can be deployed into space via a single (e.g., commercially available) launch vehicle and requires no human intervention to set-up and activate.

A variant of the system can be place on a geostationary orbit (GEO). The GEO positioned system is placed in a position that is >70 times higher than a LEO and the deployment is much more difficult and requires the orbit system to be assembled. Also the system requires more powerful focusing optics. But the system on GEO orbit can be focused in the same ground point and does not need the continuous steering used in some embodiments of the LEO systems.

FIG. 1 depicts the overall concept of the present solar power beaming system, showing a large solar collector 10 in space, a module 12 that includes a transport container and hydrogen generator as well as a doped pumped laser and focusing and beam steering optics, which altogether produce a coherent laser beam 14 that is directed to a receiving station on Earth.

Applications of the present invention include power transport from space to the ground for commercial energy applications and for power sources for isolated and remote locations on the earth's surface without negative environmental impacts, including military installations, data collection installations and isolated civilian population centers. The invention will be useful to as power sources for maritime platforms, such as ships or barges and for airborne remote platforms, such as planes, balloons and dirigibles.

The present solar power beaming invention uses modern advances in laser and optical technology to greatly reduce the weight and complexity of the power beaming system, making possible the development of a system that can be delivered into orbit at low cost, and which will deploy and operate automatically. The present invention utilizes technologies including a launch vehicle, a (e.g., inflatable) solar concentrator, foldable optics and advances in solar cell technology.

### BRIEF DESCRIPTION OF THE DRAWINGS

The accompanying drawings, which are incorporated into and form a part of the disclosure, illustrate embodiments of the invention and, together with the description, serve to explain the principles of the invention.

FIG. 1 illustrates a general embodiment of the present solar power beaming system.

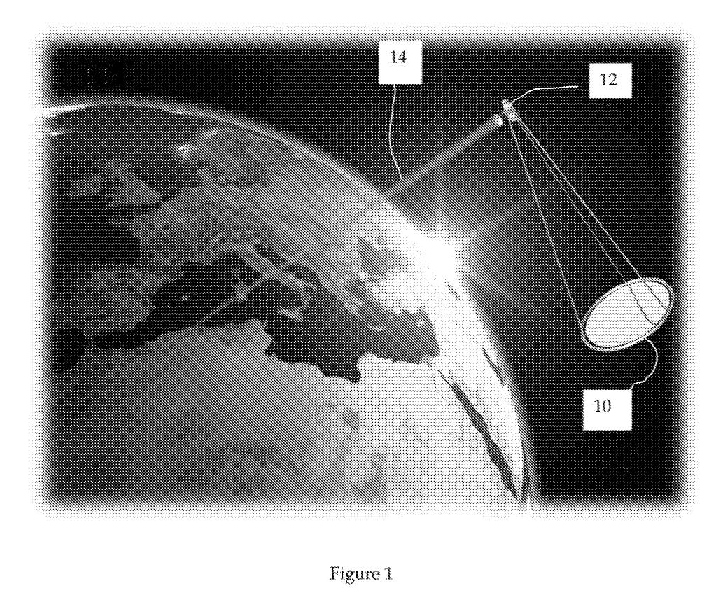

FIG. 2 shows an overview of an embodiment of the present solar power beaming system.

FIG. 3 shows a commercially available, inflatable, rigidizable and lightweight solar reflector.

FIG. 4 illustrates a method by which multiple arrays of Concentrator Photovoltaic (CPV) cells, developed for space applications by the National Renewable Energy Laboratory (NREL), can be folded for compact transport into earth orbit, then remotely unfolded for operation.

FIG. 5 shows an electrically pumped laser diode array providing low beam quality light to a laser gain medium, which has thermal control, and which provides a high quality output beam,

FIG. 6 shows a lightweight, foldable diffractive optics used to focus the laser light onto the ground receiver.

FIG. 7 shows a molten salt generator configuration for producing electricity.

FIG. 8 shows multiple power receiving stations on Earth.

FIG. 9 shows a wind farm providing electricity to laser, which produces a beam that is relayed by a reflector located on a tower.

### DETAILED DESCRIPTION OF THE INVENTION

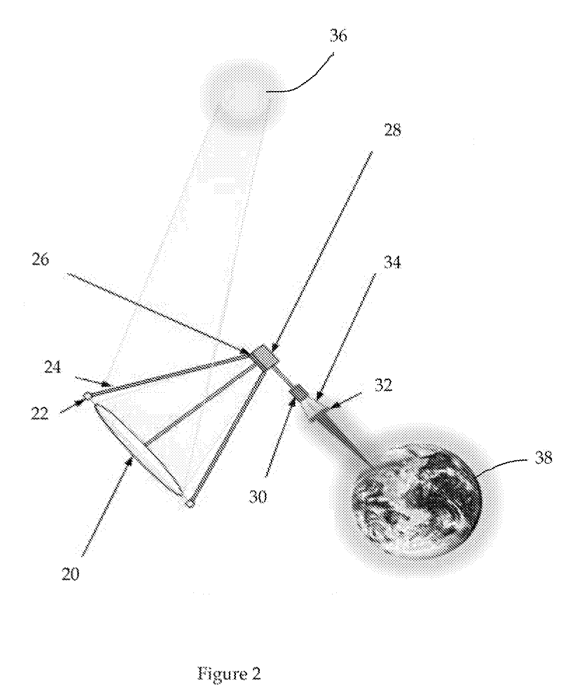

Embodiments of the present invention provide continuous collection of solar energy in space and conversion of this energy to laser energy which is beamed to receiver stations located at the earth's surface. A solar light weight concentrator is used to capture and focus the solar energy onto an electrical energy generator. This energy is transformed into a high intensity, coherent laser beam and transmitted via a set of focusing optics to select locations on earth. FIG. 2, as detailed below, provides a top-level overview of the entire process used in embodiments of the invention. The present system eliminates the high costs associated with previous concepts, making the efficient harvesting of energy from space both feasible and affordable. Advances in laser and optical technology have greatly reduced the weight and complexity of the power beaming hardware of the present invention, making possible the development of a system that can be delivered into orbit at low cost and which will deploy and operate automatically. Advanced technologies are used in the present system. Laser efficiency is now comparable with the efficiency of microwave devices. The weight/power ratio of the laser system is greatly reduced. The delivery of the laser system to orbit is greatly simplified due to the significant reduction in mass and volume. In some embodiments, inflatable, light weight mirrors that were developed by industry can be used to concentrate light of the collected solar energy, which reduces the area and weight of the solar panels in space. Lightweight, foldable diffractive optics can be used to focus and direct the laser beam to the Earth's surface.

Referring to FIG. 2, components of the invention include a solar concentrator 20, an inflatable Torus tensioning structure 22, inflatable and rigidizable support columns 24, a foldable solar cell 26, which is part of an electricity generator 28, a megawatt class laser system 30 and a diffractive lens 32. Although the beam steering system 32 is shown in this view to be between the laser 30 and the diffractive optic 34, it can also be located after the diffractive optic. Other components of the invention shown infra include an earth based solar collector and a power generation station. The solar concentrator, electricity generator, megawatt class laser system and focusing and beam steering optics are placed in orbit, preferably a LEO or a geostationary orbit, by a launch vehicle. For illustrative purposes, the figure also shows the sun 36 and the earth 38.

Solar Concentrator

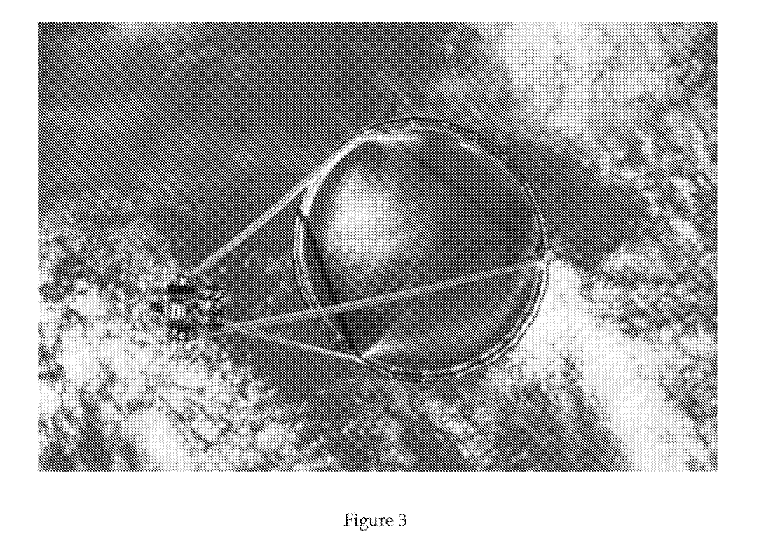

FIG. 3 shows a picture of a deployed commercially available inflatable, rigidizable and lightweight space structure manufactured by L'Garde, Inc. This company has successfully demonstrated a 14-meter version of this type of structure as part of the Inflatable Antenna Experiment (IAE) in May, 1996. The entire structure is fabricated from thin flexible membrane materials and consists of (a) a reflector surface, and a transparent canopy used to form a closed cavity so that inflation gases put tension on the two membranes; (b) a multiple layer torus structure that supports the concentrator/canopy assembly through a large number of attachment points around its perimeter, and (c) three multiple-layer struts that interface the torus with the transport package containing the remaining system components.

Electricity Generator

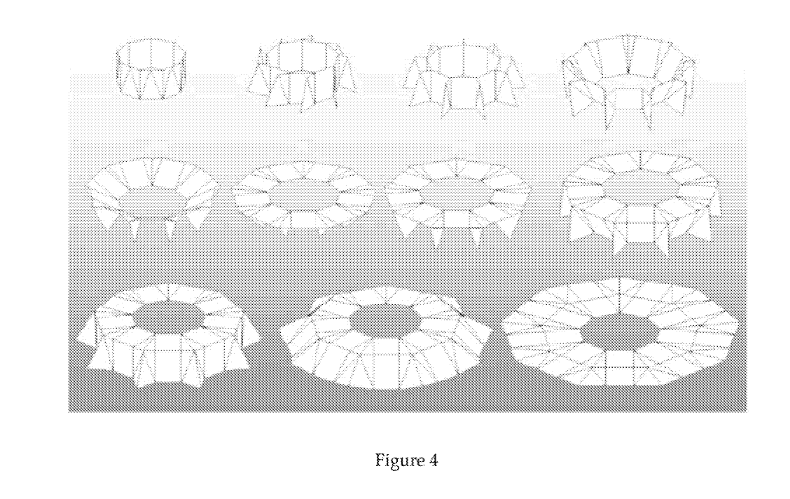

FIG. 4 shows a foldable solar cell, referred to as the Concentrator Photovoltaic (CPV) cell, developed for space applications by the National Renewable Energy Laboratory (NREL). This thin, lightweight cell transforms (300×) concentrated solar radiation into electricity with an efficiency of around 40%. EMCORE Corporation of Albuquerque, N. Mex. currently manufactures multi-junction cells using NREL's technology. See http://www.emcore.com. EMCORE's high efficiency multi-junction cells have a significant advantage over conventional silicon cells in concentrator systems because considerably fewer and smaller solar cells are required to achieve the same power output.

The solar concentrator of this invention directs the sunlight onto the very small, highly efficient multi-junction solar cell array. This allows for the substitution of the costly and heavy semiconductor PV cell material, for the more cost-effective solar reflector. The high-energy output from this more efficient system, and the savings in costly semiconductor area, make the application of CPV technology economically advantageous. For example, under 300-sun concentration, 1 cm² of solar cell area produces the same electricity as would 300 cm² without concentration. This is particularly significant considering the general cost and weight constraints inherent to LEO launches. The CPV cell array of the electricity generator utilizes a foldable design, as does the diffractive optics lens described infra. The CPV cell array of FIG. 4 is shown to unfold from top left to bottom right.

Megawatt Class Laser System

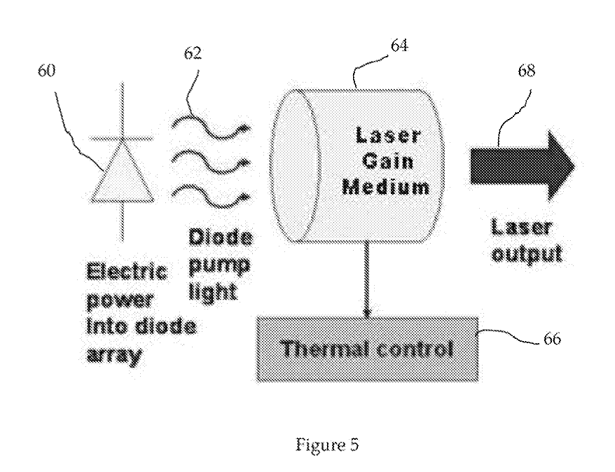

Since the advent of lasers over four decades ago, solid state and gas lasers have followed largely separate development paths, with gas lasers being based either on direct electrical discharge for pumping or luminescent chemical reactions, and dielectric solid-state lasers being pumped by flash lamps and semiconductor diode laser arrays. The diode pumped laser system transforms low beam quality diode radiation into high beam quality laser output with very high efficiency. FIG. 5 shows an electrically pumped laser diode array 60 providing low beam quality light 62 to a laser gain medium 64, which has thermal control 66, and which provides a high quality output beam 68.

One of the characteristic features of the diode pumped laser is its very small quantum defect. The diode pumped alkali laser (DPAL) embodiment discussed below has a quantum defect of about 2%, allowing almost elastic conversion of pump photons to high beam quality laser photons. This laser is unique among diode pumped lasers in utilizing fully allowed electric-dipole transitions for both pump excitation and laser extraction. This gives high optical efficiencies, and also very high cavity gains ideally matched to simple and robust unstable resonator geometries, providing a pathway to very high beam quality. Based on experimentally validated first-principles physical models, power-scaled systems will achieve unprecedented optical-to-optical efficiencies of 65-70% using today's diode arrays, and enable fully packaged systems at <5 kg/kW (system mass to power output). The laser efficiency from electricity to light can reach 50%, with a 5 kg/KW weight-to-power ratio and very good beam quality, which is a key requirement for propagating the laser beam from space to collection receivers on Earth.

Diode pumped alkali lasers are described in, e.g., U.S. Pat. No. 7,286,575, incorporated herein by reference, U.S. Pat. No. 7,145,931, incorporated herein by reference, U.S. Pat. No. 7,082,148, incorporated herein by reference, U.S. Pat. No. 7,061,960, incorporated herein by reference, U.S. Pat. No. 7,061,958, incorporated herein by reference, U.S. Pat. No. 6,693,942, incorporated herein by reference, and U.S. Pat. No. 6,643,311, incorporated herein by reference.

Focusing and Beam Steering Optics

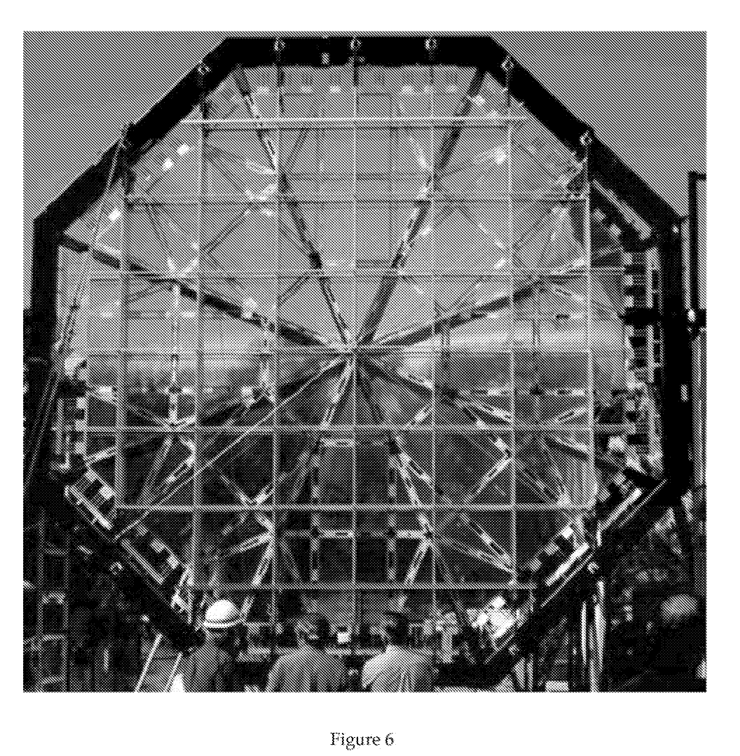

Another breakthrough technology developed at LLNL, and included in embodiments of the invention, is foldable, lightweight diffractive optics (Fresnel lens), used to focus the laser light onto the ground receiver. See FIG. 6. The unique design of the optic provides a very compact packaging for launch, and allows it to unfold automatically when deployed in orbit. See Hyde R A, Dixit S N, Weisberg A H, Rushford M C. Eyeglass: A Very Large Aperture Diffractive Space Telescope. SPIE-Int. Soc. Opt. Eng. Proceedings of the SPIE—The International Society for Optical Engineering, vol. 4849, 2002, pp. 28-39. USA. Beam steering optics for providing directionality of the laser beam to an earth receiver station can be placed between the laser and the diffractive optic, or can be placed after the diffractive optic (between the optic and earth). Such steering systems are known in the art.

Solar Collector

The laser system is driven by the electricity generated from the collected solar energy and produces a laser beam that is directed to the receiver stations on Earth. Embodiments of this laser are capable of megawatt-class power level near infrared wavelength beams that are suitable for efficient transmission through Earth's atmosphere. The laser is focused onto the receiver, which can be, e.g., a 5-meter diameter, meter, foldable diffractive lens, of the same type as discusses above.

The ground receiver captures the laser beam energy at the earth's surface. For a focusing lens in space with a diameter (D) of 5 meters and perfect beam quality, the spot size diameter (d) of the laser on the ground is given by the expression

$$d = \frac{4 λ F}{π D}$$

where λ is laser wavelength and F is the distance of the receiver on Earth to the orbiting focus lens. A wavelength (λ) of ˜0.8 μm and a relatively low orbit height (F) of ˜400 km, correspond to a minimal laser spot size (d) of ˜0.1 m. At times when the receiver will be on horizon, the distance from the orbiting focus lens to the receiver will increase by ˜√2RF, or ˜2200 km, where (R) is the radius of the earth. In this situation, the footprint of the laser (d) at the receiver will be ˜0.5 m. To be conservative, and to take into account inefficiencies in the transport of the laser beam (jitter, etc.), a receiver with a diameter (d) of 5 meters can be used. For this case, effectively aiming the laser from space orbit to the receiver on Earth requires a pointing accuracy of about 2.5 μrad, a value that has been demonstrated on projects having similar long distances of travel, such as the National Ignition Facility at LLNL.

Power Generation Station

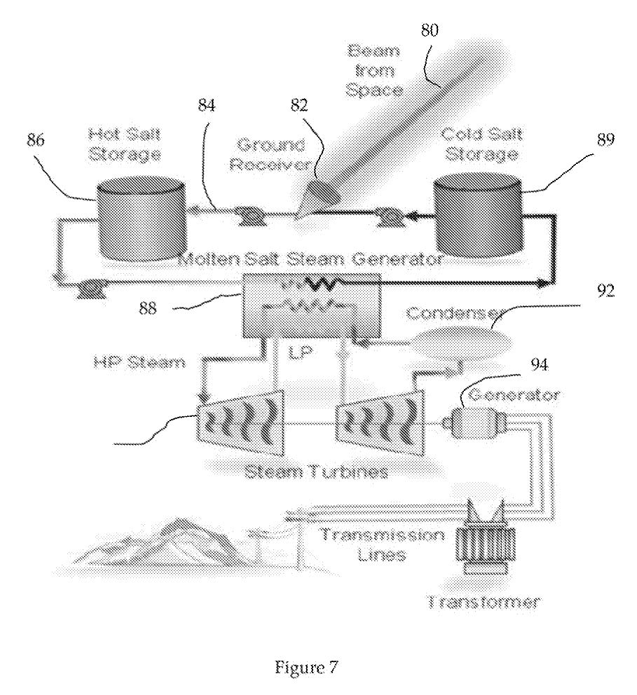

Embodiments of the power generation station that is located on Earth use molten salt as the medium to capture and store the received energy, and is incorporated into a generator system utilizing steam turbines and an electrical generator. The electricity is then sent via transmission lines to its intended destination. A molten salt generator configuration (as shown in FIG. 7) is one of the options available for the terrestrial power generation station. Another option is the direct photovoltaic converter light to electricity. Due to the monochromaticity of laser light, the electronic structure of the converting elements for such a device can be optimized for specific photon energy, and the achieved efficiency of transformation to electricity can reach about 70%. In the figure, a laser beam 80 from space is collected by solar collector 82, which heats the salt mixture that is flowing in a conduit 84. A portion of the molten salt is stored in a hot salt storage container 86 and a portion continues to travel in the conduit. The molten salt mixture heats liquid to steam in a container 88, and the molten salt mixture continues in the conduit and a portion is stored in a cold salt storage container 89, after which a portion continues in the conduit back to be heated be heated by the laser beam. Steam produced in container 88 drives steam turbines 90 and is cooled in condenser 92 to then return to container 88. Steam turbines 90 drive an electricity generator 94 to produce electricity which is provided to end users by techniques known in the art. Other techniques for generating electricity from the laser beam (e.g., a photovoltaic panel) are usable, and will be apparent to those skilled in the art based on the present disclosure.

Launch Vehicle

An attribute of embodiments of the solar power beaming system is its extremely light weight, such that the entire space based system can be put into low earth orbit (LEO) using a single, commercially available heavy lift launch vehicle. In addition, embodiments of the invention require no human intervention for deployment and activation in space, and are brought to full operational mode remotely from Earth. The advances in weight reduction and remote deployment overcome significant cost challenges that have previously prevented development of space based solar power concepts from a practical perspective.

Placement of the solar collector, the energy generator, the laser and the focusing toptics in low earth orbit (LEO) provides advantages including: (i) the payload to cost ratio is much less expensive for LEO packages versus geosynchronous orbits (GEO: ˜36,000 kilometers) having a cost differential of at least a factor of two, if not more; (ii) the maximum allowable payload for a single launch into LEO using the SpaceX Falcon 9 is over double that of a GEO launch; and (ii) the distance the laser beam has to travel is approximately 90 times less for a LEO versus a GEO and in addition, the pointing and stability accuracy of the laser system is much reduced for a space-based system orbiting in LEO. A system orbiting in LEO (versus GEO), however; does experience more atmospheric drag due to its closer proximity to Earth and because of this, small rocket motors (such as the gas generators used to inflate the solar collector) will be required to fire intermittently to keep the space-based solar power system from losing altitude.

Deployment is accomplished by sequentially introducing inflation gas to the stowed struts, torus and reflector/canopy. Once LEO is reached, the stowed inflatable structure ejects from the transport package via a spring-loaded plate. Next, the resultant strain energy from stowage of the inflatable struts initiates their deployment, with completion by inflation. Shortly thereafter, deployment of the torus initiates by release of its strain energy, then again completed by inflation. After the support structure has been completely deployed; the reflector and canopy are inflated to their proper pressures.

Strain from completed pressurization of the struts and torus will cause their Sub-Tg membrane material to “rigidize”, thus forming a stiff support structure for the rest of the system. The reflector membrane will also rigidize upon pressurization, after which, the clear canopy will remotely disengage from the deployed Solar Reflector.

The structure is relatively inexpensive, as it is constructed entirely of readily available membrane materials and does not require any high-precision mechanisms, complicated structures or electro-mechanical devices. In addition, the structure is very light, with a membrane thickness approximately 6 to 8 microns for the reflector and canopy, and a few hundred microns for the torus and struts. High deployment reliability is realized since the structural elements simply unfold from the stowed configuration as they are pressurized sequentially. The deployment is similar in fashion to that of an escape chute deploying from an airliner.

Thermal Management

Thermal management is a consideration for the present space-based solar power station, since the only available cooling mechanism will be losses via radiation to outer space. The high efficiency of the solar panels and the efficient laser system greatly helps to resolve the problem. For embodiments of the present system, about 4 MW of energy must be removed. A practical way to do this is by thermal radiation from the surfaces of the subsystem components and structure. The advantage of the diode pumped laser is not only its high efficiency, but also in its robust operation at high temperatures (T˜440K), which is about the temperature for the entire system, assuming good thermal contact of the components. The blackbody radiation flux at this temperature is:

P=σT⁴≈10⁵T_{eV}⁴W/cm²˜0.2W/cm²

Considering only the concentrator area of 3600×2 m² (taking into account the radiation from the rear surface), the total radiated energy will be ˜14 MW. Hence, if all elements of the system are connected using aluminum-coated inflatable columns, the radiative losses will be sufficient to support steady-state system operation.

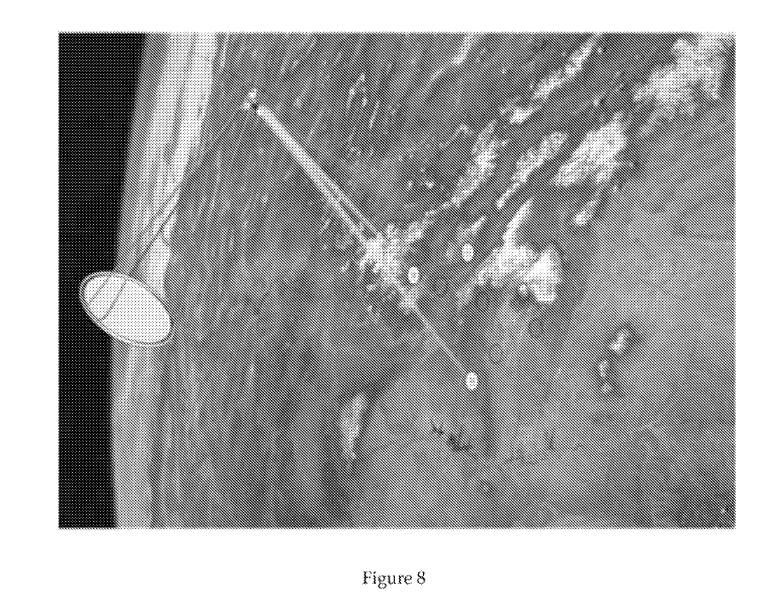

Embodiments of a fully operating space based solar power system can have multiple solar power beaming stations orbiting the Earth, and, as shown in FIG. 8, multiple power receiving stations on Earth. This concept allows power beaming to continue during times of inclement weather at some receiver stations, and increases the total area to which the collected solar energy can be supplied. Solar power beaming stations in LEO will orbit the Earth about every 90 minutes. For any given receiver station on Earth, the solar power beaming station will be able to illuminate that specific receiver for approximately 9 minutes at the megawatt power level. After the 9 minutes, the solar power beaming station will not be able to “see” that particular receiver, and will therefore “switch” to another receiver on earth. This scenario can happen continuously as desired. Assume that 10 stations were all positioned correctly, power beaming will be maintained quasi-continuously, consecutively to each of these 10 stations, 9 minutes at a time.

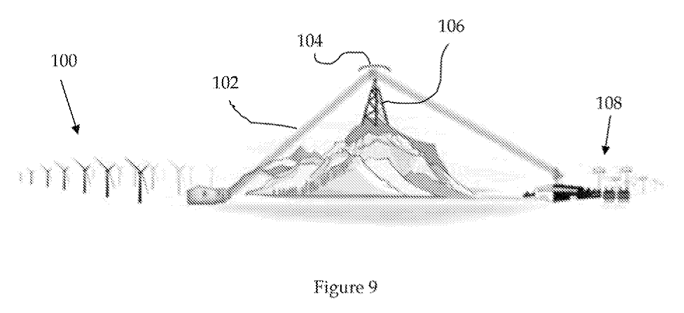

Embodiments of the present space laser system have a high (˜50%) efficiency of electricity conversion to laser radiation. The conversion of laser energy back to electricity can be done with an efficiency reaching about 70%. As a result, it is also attractive to use the laser system for ground energy transmission. Another application of this technology is in conjunction with wind energy. For the most part, large wind farms are situated in remote places having good wind patterns, but frequently surrounded by rugged terrains. The construction of transmission lines to retrieve the harvested power is expensive and invasive to natural habitats, quite often leading to a stream of environmental objections. Laser-based energy beaming is flexible, noninvasive, and can be an integral part of a transmission system. FIG. 9 shows a wind farm 100 which provides electricity to power a laser which produces a beam 102 that is relayed by a reflector 104 located on a tower 106. The reflected light is relayed to a power station 108 that provides electricity to various loads. Although power beaming can be weather sensitive, it remains consistent with the intrinsic intermittency of wind energy.

As an estimate of parameters for an embodiment of the invention, consider a 1 Megawatt diode pumped laser. An electrical efficiency of about 50% is expected for this kind of laser system. For the solar panel, consider a cell having efficiency of approximately 40%. Using the above stated values, the solar energy flux incident on the cell must be about 5 MW. Since solar energy flux in space near the Earth is approximately 1.4 KW/m², the area of the solar collector must be at least 3600 m², and the solar panel area must be 12 m².

Thus, a general embodiment of the invention is a laser based system for harvesting solar energy in space and transporting energy to the ground. Such embodiment comprises (i) a solar concentrator for collecting and concentrating solar energy; (ii) an electricity generator positioned to receive and convert the solar energy to electricity; (iii) a laser powered by the electricity, wherein the laser will produce a laser beam; and (iv) at least one optic configured to contribute to the propagation of the laser beam from space to earth. The laser comprises a diode pumped laser that is powered by the electricity. The at least one optic comprises a foldable diffractive lens configured to contribute to the propagation of the laser beam from space to earth by focusing the laser beam from space to earth, e.g., by focusing the laser beam from space to at least one ground receiver located on earth. A laser beam steering system is configured to further contribute to the propagation of the laser beam from space to earth. Conversion of the laser energy to electricity can be achieved, e.g., by at least one molten salt steam generator or, e.g., a photovoltaic panel, wherein the diffractive lens is configured to contribute to the propagation of the laser beam from space to the photovoltaic panel on the earth. The solar reflector is foldable, inflatable and rigidizable and comprises mylar. An inflatable torus tensioning structure is attached at one end to the solar reflector and at the other end to the electricity generator. The electricity generator comprises at least one foldable solar panel that comprises, e.g., a photovoltaic panel. The laser can comprise an array of diode pumped lasers that are powered by the electricity. The diode pumped laser can comprise a diode pumped alkali laser. The space based elements of the invention are preferably placed in LEO or in a geostationary orbit. Embodiments of the invention contemplate the use of the above described invention.

The foregoing description of the invention has been presented for purposes of illustration and description and is not intended to be exhaustive or to limit the invention to the precise form disclosed. Many modifications and variations are possible in light of the above teaching. The embodiments disclosed were meant only to explain the principles of the invention and its practical application to thereby enable others skilled in the art to best use the invention in various embodiments and with various modifications suited to the particular use contemplated. The scope of the invention is to be defined by the following claims.

We claim:

1. An apparatus, comprising:
a solar concentrator for collecting and concentrating solar energy;
an electricity generator positioned to receive and convert said solar energy to electricity;
a laser powered by said electricity, wherein said laser will produce a laser beam; and
at least one optic configured to contribute to the propagation of said laser beam from space to earth.

2. The apparatus of claim 1, wherein said laser comprises a diode pumped laser that is powered by said electricity.

3. The apparatus of claim 2, wherein said at least one optic comprises a diffractive optic.

4. The apparatus of claim 3, wherein said diffractive optic comprises a diffractive lens.

5. The apparatus of claim 4, wherein said diffractive lens is configured to contribute to the propagation of said laser beam from space to earth by focusing said laser beam from space to earth.

6. The apparatus of claim 5, wherein said diffractive lens is configured to contribute to the propagation of said laser beam from space to earth by focusing said laser beam from space to at least one ground receiver located on earth.

7. The apparatus of claim 1, further comprising a steering system configured to further contribute to the propagation of said laser beam from space to earth.

8. The apparatus of claim 4, further comprising at least one molten salt steam generator, wherein said diffractive lens is configured to contribute to the propagation of said laser beam from space to said at least one molten salt steam, generator on said earth.

9. The apparatus of claim 2, further comprising a photovoltaic panel, wherein said diffractive lens is configured to contribute to the propagation of said laser beam from space to said photovoltaic panel on said earth.

10. The apparatus of claim 1, wherein said solar concentrator comprises a solar reflector.

11. The apparatus of claim 10, wherein said solar reflector is inflatable and rigidizable.

12. The apparatus of claim 10, wherein said solar reflector is foldable, inflatable and rigidizable.

13. The apparatus of claim 10, wherein said solar reflector comprises mylar.

14. The apparatus of claim 11, further comprising a torus tensioning structure attached at one end to said solar reflector and at the other end to said electricity generator.

15. The apparatus of claim 14, wherein said torus tensioning structure is inflatable.

16. The apparatus of claim 1, wherein said electricity generator comprises at least one solar panel.

17. The apparatus of claim 16, wherein said at least one solar panel is foldable.

18. The apparatus of claim 16, wherein said at least one solar panel comprises a photovoltaic panel.

19. The apparatus of claim 1, wherein said laser comprises an array of diode pumped lasers that are powered by said electricity.

20. The apparatus of claim 2, wherein said diode pumped laser comprises a diode pumped alkali laser.

21. The apparatus of claim 3, wherein said diffractive optic is foldable.

22. A method, comprising:
collecting and concentrating solar energy with a solar concentrator to produce concentrated solar energy;
converting, with an electricity generator, said concentrated solar energy to electricity;
electrically energizing, with said electricity, a laser to produce a laser beam; and
directing, with at least one optic, said laser beam from space to earth

23. The method of claim 22, wherein said solar concentrator, said electricity generator, said laser and said at least one optic are located in space.

24. The method of claim 22, wherein said laser comprises a diode pumped laser that is powered by said electricity.

25. The method of claim 24, wherein said at least one optic comprises a diffractive optic.

26. The method of claim 25, wherein said diffractive optic comprises a diffractive lens.

27. The method of claim 26, wherein said diffractive lens is configured to contribute to the propagation of said laser beam from space to earth by focusing said laser beam from space to earth.

28. The method of claim 27, wherein said diffractive lens is configured to contribute to the propagation of said laser beam from space to earth by focusing said laser beam from space to at least one ground receiver located on earth.

29. The method of claim 22, further steering said laser beam from space to earth.

30. The method of claim 26, further comprising at least one molten salt steam generator, wherein said diffractive lens is configured to contribute to the propagation of said laser beam from space to said at least one molten salt steam generator on said earth.

31. The method of claim 26, further comprising a photovoltaic panel, wherein said diffractive lens is configured to contribute to the propagation of said laser beam from space to said photovoltaic panel on said earth.

32. The method of claim 22, wherein said solar concentrator comprises a solar reflector, wherein said solar reflector is foldable, inflatable and rigidizable.

33. The method of claim 31, wherein said solar reflector comprises mylar.

34. The method of claim 31, further comprising a torus tensioning structure attached at one end to said solar reflector and at the other end to said electricity generator.

35. The method of claim 34, wherein said torus tensioning structure is inflatable.

36. The method of claim 22, wherein said electricity generator comprises at least one solar panel.

37. The method of claim 36, wherein said at least one solar panel is foldable.

38. The method of claim 36, wherein said at least one solar panel comprises a photovoltaic panel.

39. The method of claim 22, wherein said laser comprises an array of diode pumped lasers that are powered by said electricity.

40. The method of claim 22, wherein said laser comprises a diode pumped alkali laser.

41. The method of claim 25, wherein said diffractive optic is foldable.

42. The method of claim 22, wherein the step of directing, with at least one optic, said laser beam from space to earth includes directing, with at least one optic, said laser beam from a location in space to at least one location on earth, wherein said location in space is selected from a group consisting of a low earth orbit and a geostationary position relative to the earth.
